(19) United States
(12) Patent Application Publication
(10) Pub. No.: US 2014/0099612 A1
(43) Pub. Date: Apr. 10, 2014

(54) SYSTEMS AND METHODS FOR AFFIRMATION CREATION AND DELIVERY

(71) Applicants: Jonathan Strietzel, Long Beach, CA (US); Daryll Merchant, Playa Del Rey, CA (US); Joseph Strietzel, Lakewood, CA (US)

(72) Inventors: Jonathan Strietzel, Long Beach, CA (US); Daryll Merchant, Playa Del Rey, CA (US); Joseph Strietzel, Lakewood, CA (US)

(21) Appl. No.: 14/014,273

(22) Filed: Aug. 29, 2013

Related U.S. Application Data
(60) Provisional application No. 61/694,398, filed on Aug. 29, 2012.

(51) Int. Cl. G11B 20/10

(52) U.S. Cl. CPC G11B 20/10527
USPC 434/236

(57) ABSTRACT

A device for recording and playing back an affirmation, comprising a recording unit configured to record the affirmation; a setup engine configured to associate at least on of the following with the recorded affirmation: volume level, imagery that displays on a viewing medium during affirmation playback, sub-sonic sound types, subconscious sound types, standard audio types, pattern types, duration, alarm sounds, playback sequences, segmented playback, wake-up times or wake-up alarms, vibration triggering, vibration types, signal processing, data reporting, pitch, tone, frequency and bass settings; a storage medium configured to store the affirmation as prepared by the setup engine; and a playback unit configured to play the affirmation back in accordance with at least one of the following payback modes: meditation mode and sleep mode.

### BACKGROUND

1. Technical Field

The embodiments described herein are related to affirmation creation and playback through a recording and playback medium.

2. Related Art

Conventionally, affirmations are audio sound tracks pre-recorded and played back for users. Affirmations are typically not heard in the users own voice but in some other persons voice, and often, affirmations are spoken out loud by the user and never recorded by a device. Another related piece of art would be alarm clocks that allow users to play back custom music or recordings upon a timer expiration.

### SUMMARY

Systems and method for affirmation recording/creation, storage and various playback methods and options are described herein.

According to one aspect, the affirmation delivery system would allow the user to record their own voice through a recording medium and play back/listen to the affirmation, thereby planting the affirmation in their brains during a meditation or sleep period. The creation and playback of these affirmations could be used for, but not limited to, mental healing, wellness, connectivity between human beings, synchronicity of mankind across multiple devices and across multiple timezones, overall body health, healing, sports performance, brain growth and development, memory/recall, sleep stability, dream alteration and programming, sleep efficiency, growth, remoting, group connectivity, calculation/analysis, brain stimulation, inception and much more.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example of an affirmation recording and playback experience in accordance with one embodiment; and

FIG. 2 is a diagram illustrating an example of a pre-recorded affirmation being selected for a playback experience in accordance with another example embodiment.

### DETAILED DESCRIPTION

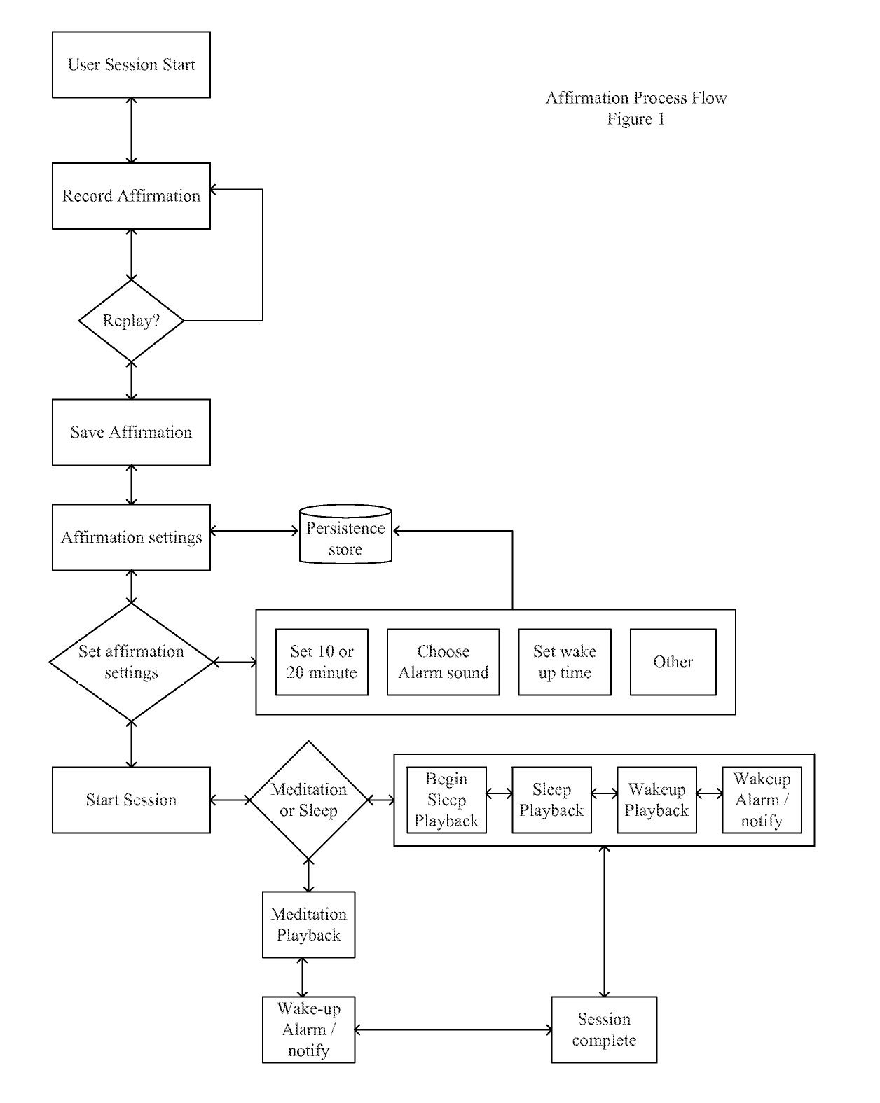

FIG. 1, Affirmation Process Flow, is a diagram illustrating an example embodiment of a typical flow for an affirmation recording/creation and playback session where the user is actually creating the affirmation and utilizing that affirmation during a session. Each session could vary in length, binaural audio, content and volume, but the idea and flow behind the basic experience of creating an affirmation is as follows. The device is turned on and the users session with the apparatus or software is initiated. Although there are a number of activities a user may select based on the type of options given to him or her, for example, if an mobile phone application is opened, a user might take different paths that may ultimately lead them to the creation of a new affirmation. However the user chooses to get to affirmation creation, the diagram is simply focusing on the process that one might typically undergo when creating a new affirmation for meditation or sleep playback. One the user begins their session labeled “User Session Start” they will ultimately come to the point in the application or device experience that they will be presented with an option to create/record a new affirmation by speaking into a recording device medium. They may desire to record their affirmation on the fly or they may choose to read or repeat the audio from a pre-created affirmation. Once they have taken whatever steps are necessary to record their affirmation, they might have a choice to replay that recording to make sure its of a desired quality. This step is purely an experiential step and it is completely at the discretion of the application designer to offer this validation step in the process. Assuming that the recording is satisfactory, the system would have the choice to further optimize the recording by adding in necessary audio components, patterns, vibrations if necessary and then save the affirmation and archive it automatically in its own format for later retrieval or it might be named and tagged by the actual user themselves. Once the affirmation is saved, the system can actually set the affirmation up for playback by utilizing standard or default software settings which may include but not limited to, volume level, imagery that displays on a viewing medium during affirmation playback, sub-sonic sound types, subconscious sound types, standard audio types, pattern types, duration, alarm sounds, playback sequences, segmented playback, wake-up times or wake-up alarms, vibration triggering, vibration types, signal processing, data reporting, pitch, tone, frequency and bass settings. Once the affirmation is setup automatically by the software or by the user, all of the necessary settings are saved into a persistent store for future playback and for its current playback. Once the affirmation is setup it is ready for playback. Affirmation playback can be done in number of ways but not limited to, for example, “Meditation Mode” which would be a standard play back as one meditates for a certain duration of time, another mode would be “Sleep Mode” where the user is desiring to playback their affirmation as they are falling asleep for the set duration of time. After they have fallen asleep, the affirmation could contain but not limited to the following various forms of content, for example, subsonic audio, binaural audios, low volume audio or vibrations for the user during their sleep state to help create and ensure an optimal sleep. In “Sleep Mode” the user would set a “Wake-up Time” or “Alarm Time”, a time in the morning in which they are planning to wake-up. The affirmation software would take into account the duration and wake the user up by playing back their affirmations for the duration before their “Wake-up Time” expires, in one example the affirmations would playback during the users Alpha Wave sleep, thereby planting the affirmation in the users subconscious, the final sequence ending around or precisely on the “Wake-up Time” or “Alarm Time”. The affirmation playback sequencing can occur at a set interval or it could be random. For example, in one example, affirmations are played back to the user once a minute for 10 minutes (10 Minute Duration). An affirmation might play for say 20 seconds of audio that was recorded from the user, for the remaining 40 seconds, the user could hear audio, but not limited to the following which could be no sound at all (the system turns off or goes offline), silent audio, subconscious audio, a highly tuned sound, a specialized sound pattern, a combination of sounds, a combination of pulses, timed sounds or pulses, audio vibration, binaural audio, subsonic audio and any other form of pulse that might stimulate or program the brain in any way. During this waiting period, the software could also pause, turn of and re-engage at the right moment when the system knows it needs to play back the users recorded affirmation again thereby continuing the duration. It should be stated that that although we are using two modes “Meditation Mode” and “Sleep Mode” as an example, playback modes should not be limited to these playback modes. New modes could be created and presented to the user at any time, for example, but not limited to, a software update. Regardless of the type of playback “Meditation Mode” or “Sleep Mode”, the user will have to choose their playback mediums. For example, the user would choose between, but not limited to, any of the following, the mobile phone speaker, a speaker network (Multiple Speakers), peripheral speaker(s) such as a mobile phone doc, surround sound speakers, in ear speakers, wireless speaker(s) such as WiFi or BlueTooth, wired (Cabled for example) or wireless headphones such as a WiFi headset or BlueTooth headset.

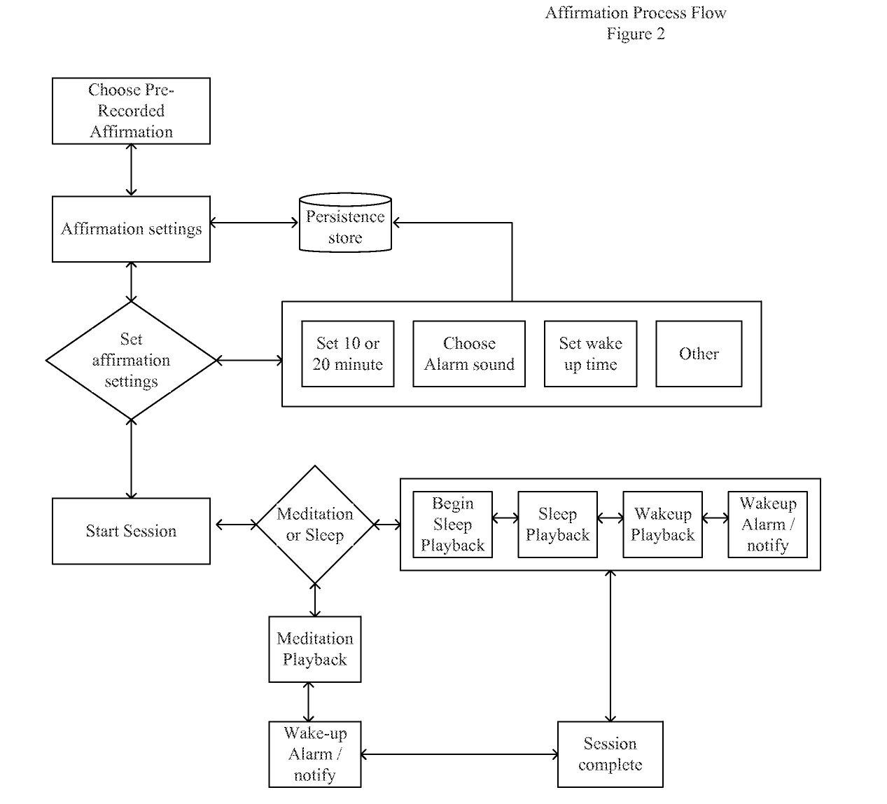

FIG. 2 is a diagram illustrating an example embodiment of a typical flow for an affirmation selection and playback session where the user is selecting a pre-recorded and saved affirmation for affirmation playback from a list of pre-recorded affirmations. These pre-recorded affirmations could be affirmations that have been created by the user or other individuals. Each session can vary in length, binaural audio mix, content and volume, but the idea and flow behind the basic experience of creating an affirmation is as follows. The device is turned on or the software is initiated and the users session with the apparatus or software is initiated. Although there are a number of activities a user may select based on the type of options given to him or her, for example, if an mobile phone application is opened, a user might take different paths that may ultimately lead them to the creation of a new affirmation. However the user chooses to get here, the diagram is simply focusing on the process that one might typically undergo when creating a new affirmation for meditation or sleep playback. One the user begins their session labeled “User Session Start” they will ultimately come to the point in the application or device experience that they will be presented with an option to create/record a new affirmation by speaking into a recording device medium. Once they have taken whatever steps are necessary to record their affirmation, they might have a choice to replay that recording to make sure its of a desired quality. This step is purely an experiential step and it is completely at the discretion of the application designer to offer this validation step in the process. Assuming that the recording is satisfactory, the system might save the affirmation and archive it automatically in its own format for later retrieval or it might be named and tagged by the actual user themselves. Once the affirmation is saved, the system can actually set the affirmation up to play utilizing standard or default settings which may include but certainly not limited to, volume level, imagery that displays on a viewing medium during affirmation playback, sub-sonic sound types, subconscious sound types, standard audio types, duration, alarm sounds, playback sequences, segmented playback, wake-up times or wake-up alarms, vibration triggering, signal processing, data reporting, pitch, tone, frequency and bass settings. Once the affirmation is setup automatically by the software or by the user, all of the necessary settings are saved into a persistent store for future playback and for its current playback. Once the affirmation is setup it is ready for playback. Affirmation playback can be done in number of ways but not limited to, for example, “Meditation Mode” which would be a standard play back as one meditates for a certain duration of time, another mode would be “Sleep Mode” where the user is desiring to playback their affirmation as they are falling asleep for the set duration of time. After they have fallen asleep, the affirmation could various forms of content, for example, but not limited to, subsonic audio, low volume audio or vibrations for the user during their sleep state to ensure an optimal sleep. In “Sleep Mode” the user would set a “Wake-up Time” or “Alarm Time”, a time in the morning in which they are planning to wake-up. The affirmation software would take into account the duration and wake the user up by playing back their affirmations for the duration before their “Wake-up Time”, in one example the affirmations would playback during the users Alpha Wave sleep, thereby planting the affirmations in the users subconscious, the final sequence ending around or precisely on the “Wake-up Time” or “Alarm Time”. The affirmation sequencing can occur at a set interval or it could be random. For example, in one example affirmations are played back to the user once a minute for 10 minutes. An affirmation might play for say 20 seconds of audio that was recorded from the user, for the remaining 40 seconds, the user could hear audio, but not limited to the following which could be no sound at all (the system turns off or goes offline), silent audio, subconscious audio, a highly tuned sound, a specialized sound pattern, a combination of sounds, a combination of pulses, timed sounds or pulses, audio vibration, binaural audio, subsonic audio and any other form of pulse that might stimulate or program the brain in any way. During this waiting period, the software could also pause, turn of and re-engage at the right moment when the system knows it needs to play back the users recorded affirmation again thereby continuing the duration. It should be stated that that although we are using two modes “Meditation Mode” and “Sleep Mode” as an example, playback modes should not be limited to these playback modes. New modes could be created and presented to the user at any time, for example, but not limited to, a software update. Regardless of the type of playback “Meditation Mode” or “Sleep Mode”, the user will have to choose their playback mediums. For example, the user would choose between, but not limited to, any of the following, the mobile phone speaker, a speaker network (Multiple Speakers), peripheral speaker(s) such as a mobile phone doc, wireless speaker(s) such as WiFi or BlueTooth, wired (Cabled for example) or wireless headphones such as a WiFi headset or BlueTooth headset.

Both of the above processes outline the creation or selection of an affirmation and the playback of that affirmation on a singular device, but it should be noted that the system should not be limited to the simultaneous playback on a single device. In some cases, affirmations might be recorded on various devices, mixed and played back to various devices at one time, or a single affirmation, originating from a single source may be distributed and played across multiple devices at once, in sync or slightly out of sync depending on the usage and timing. In the case of multi-device playback the affirmations will be coordinated by a central “server” or software that knows how to play the affirmation or affirmations across multiple devices for certain pre-defined purposes. In most cases of affirmation creation and playback, the user could connect their affirmations to the web and socially share affirmations with each other via social media in the form of, but not limited to, text, composed messages, tweets, blog posts, audio posts, video posts, shared streams, simultaneous streams, and potentially much more. Although the above diagrams and descriptions label two major types of affirmation playback “Meditation” and “Sleep”, affirmations could be played back at any time including but not limited to live performances, live athletic events, workouts and at a sub-sonic audio level as a user carries out their day and much more. Affirmation recordings could also be recorded at different times and joined together for a combined audio track or multiple audio tracks that are all played back together at the same time or a series of audio tracks that are joined and are played back in a predetermined pattern or sequence. The playback of all of these tracks could also be randomized if desired. The key here is to allow group affirmation capability and playback that could be organized by a central server or it could be randomized.

While certain embodiments have been described above, it will be understood that the embodiments described are by way of example only. Accordingly, the systems and methods described herein should not be limited based on the described embodiments.

What is claimed:

1. A device for recording and playing back an affirmation, comprising:
a recording unit configured to record the affirmation;
a setup engine configured to associate at least one of the following with the recorded affirmation: volume level, imagery that displays on a viewing medium during affirmation playback, sub-sonic sound types, subconscious sound types, standard audio types, pattern types, duration, alarm sounds, playback sequences, segmented playback, wake-up times or wake-up alarms, vibration triggering, vibration types, signal processing, data reporting, pitch, tone, frequency and bass settings;
a storage medium configured to store the affirmation as prepared by the setup engine; and
a playback unit configured to play the affirmation back in accordance with at least one of the following payback modes: meditation mode and sleep mode.
